(19) United States
(12) Patent Application Publication
(10) Pub. No.: US 2004/0228947 A1
(43) Pub. Date: Nov. 18, 2004

(54) Diet composition and method for rearing insects

(76) Inventor: James Christopher Wiggins, League City, TX (US)

Correspondence Address: Anastassios Triantaphyllis, P.O. Box 27629, Houston, TX, 77227, US

(21) Appl. No.: 10/438,092

(22) Filed: May 14, 2003

(51) Int. Cl. A01K 1/00

(52) U.S. Cl. 426/2

(57) ABSTRACT

A composition suitable for the preparation of insect larval rearing media is disclosed. The composition includes soy fiber, soy flour, wheat germ, an agar and/or carrageenan and a vermiculite. The composition is readily mixed with hot water to form an insect larval rearing media which is suitable for the mass rearing of a variety of insects.

### TECHNICAL FIELD OF INVENTION

The present invention relates to the field of diets and methods of rearing insects and, more particularly, to the field of diets containing soy fiber. Still more particularly, the present invention relates to a composition and method for rearing insects wherein the composition contains soy fiber, a nutrient, a marine colloid gelling agent and water that is suitable for mass rearing of a large variety of insects including Monarch Butterfly (Danaus plexippus) larvae.

### BACKGROUND OF INVENTION

Insect larvae are usually reared on a variety of nutrients including soy flour, wheat flour, wheat germ which are in an aqueous solution solidified by using agar, starch, carrageenan, guar, cellulose fibers, and various plant gums. One disadvantage of those products is that they require a large amount of water, typically in the range of about 86 to about 95 percent. The high amount of water causes the production of large amounts of moist frass which can breed microorganisms that contaminate the feeding media, spread disease and oxidize and spoil the diet thereby increasing the cost of rearing. Further, because such large amounts of water are required in the formulation of these diets, the nutrients are diluted resulting in poor feed conversion.

Another disadvantage of those products is that the high molecular weight gelling agents used do not provide any nutritional or feed stimulus value to the media and diminish the nutritional value of the diet. The Marine Hydrocolloid gelling agents used are only soluble in hot boiling water after several minutes of mechanical agitation in a blender and can not be mixed effectively with the nutrient components. Accordingly, prior to adding the media thereto, they must be dissolved and, after adding the media thereto, they must be blended with time consuming mechanical agitation in a blender under hot temperature provided by steam jacket. The mechanical agitation and hot conditions can destroy the nutritional quality of the artificial diet.

Another disadvantage of the prior conventional diets is that they cannot be easily spread on the sides of the rearing container without drying out, they form only thin coats of diet, and are not satisfactory media for mass rearing. They only provide a limited feeding surface area which is usually in the bottom of the rearing cup, an area where frass accumulates. As a result, feeding larvae must burrow through layers of frass that carpets the feeding media. This can lead to disease problems. Further, when the rearing cups are inverted so that frass falls away from the diet, the agar diet at the bottom of the cup can dislodge and fall on feeding organisms.

In the book entitled “Artificial Diets for Insects, Mites, and Spiders,” IFI/Plenum, New York, N.Y., 594pp (1977), Singh discloses a variety of insect diets. U.S. Pat. Nos. 3,488,196, 3,583,871 disclose an artificial feed for silkworms that comprises a gelatinous water hydrogel soft “dough” bearing feed containing maize and/or sorghum with soy bean meal as the primary nutritive ingredient. Further, it contains 10% mulberry leaf powder. Mulberry Farms distributes the diet disclosed in those patents under the trade name Silkworm Chow. When mixed with the prescribed amount of water the diet forms a malleable dough. The diet works best as a very dry dough at the manufacturer's recommended amount of water. If less water is added the diet dries out When the water content in this matrix is increased above 75%, rearing problems such as mold, rapid oxidation, disease or refusal of the diet by larvae can result. The range of water is therefore limited in this particular formulation and fresh diet must be provided more frequently. This increases the cost of the diet in terms of materials and labor.

U.S. Pat. No. 4,840,800 discloses a diet consisting primarily of soy fiber and wheat germ. This insect rearing diet described in that patent uses the soy fiber as the gelling agent when dissolved in cold water. The resulting diet forms a moist paste that the larvae feed on. Soybean fiber is primarily composed of soybean cotyledons cell wall structures. The percentages of fiber in commercially available soy products can range from as low as 5% to as high as 75%. The percentages of protein can range from 1-14%. Insect larvae usually require artificial diets containing from 70 to 90% water. One disadvantage associated with the diet and method described in U.S. Pat. No. 4,840,800 is that it includes a wetter surface that is conducive for microorganism growth. Another disadvantage and that the formulation is less forgiving in that an exact amount of water is necessary to get the highest performance from the diet. Other limitations include difficulty of preparing large batches of the diet and in dispensing the thick dough-like paste into rearing cups. Further, the invention limits the amount of water that can be added to the soy fiber gelling agent and the diet can dry out prematurely rendering it useless and more costly. If too much or not enough water is added to the diet, the diet does not perform satisfactorily. The commercially available product that is disclosed in U.S. Pat. No. 4,840,800 contains 75% water (package insert) as compared to about 87% for soy meal agar based diets.

The disadvantages of the prior diets are overcome by the diet of the present invention. More particularly, the amount of water used may be within a wide range without affecting the effectiveness of the diet whereby there is no need to measure exact amounts of water. The amount of water used is less than that used in prior agar based diets but more than that used in the diet disclosed in U.S. Pat. No. 4,840,800 whereby the problems associated with overly wet or overly dry conditions, respectively, are eliminated.

In the prior art, the agar is first prepared before it is mixed with the dry mix and is blended, as hot molten agar with the dry mix by mechanical agitation. That is an unsafe procedure and forms nutrient gradients and agar-diet clumps at the bottom of the mixing vessel. The composition of the present invention is such that its preparation eliminates those steps whereby the preparation procedure is safer and results in a diet free of nutrient gradients. Further, the gelling agents are evenly distributed throughout the diet matrix.

In the prior art, high temperatures were encountered in the mixing process thereby degrading the product. In the present invention, the dry mixture is easily mixed with the water by adding a predetermined amount of dry mixture to a microwave-safe container containing a predetermined amount of boiling distilled water which has been brought to boiling in a microwave oven. The heating in the microwave oven sterilizes the container. The resultant mixture is homogeneous and its components are not altered or degraded by high temperatures.

Prior art agar based diets dry out quickly when applied on the sides of rearing containers. The composition of the present invention provides for an increased feeding surface area as the diet can be spread in a thick or thin layer on the sides of the rearing container without drying out.

The diet can be spread on vertical surfaces which are separate and apart from surfaces that are covered by frass. Thus the diet does not get contaminated by frass or oxidized and uneaten diet does not need to be discarded. Further, the larvae do not need to come into contact with large amounts of frass that has settled on the diet feeding surface thereby improving sanitation in the rearing cup, decreasing the incidence of disease and reducing the refusal of frass contaminated diet by larvae.

The diet disclosed by the present invention contains water absorbing material that absorb the water present in the rearing environment thereby eliminating the problem of condensation in the rearing container and the associated disease problems. The diet remains fresher longer, is less likely to oxidize (turn brown), and is less likely to be refused by feeding larvae

In the prior art diets, there is a problem with premature pupation resulting in smaller, less healthy, and less vigorous adults. The composition of the present invention and the method of applying it result in much larger adults than those raised on cellulose and agar based controls.

Another advantage of the present invention is that the composition provides for a more natural host plant environment for feeding larvae. When the diet is spread along the sides of the rearing container, the surface formed resembles that of a leaf When fed with the diet of the present invention, larvae consume the diet much like they would consume a leaf in a repetitive semi-circle manner.

Still another advantage of the present invention is that it may be used to rear monarch butterfly (Danaus plexippus) to a fully developed adult butterfly. No prior art diets have accomplished such rearing.

These and other advantages of the present invention will become apparent from the following description.

### SUMMARY OF THE INVENTION

According to the present invention, a composition is disclosed for the preparation of insect larval rearing media. The composition includes a water absorbing agent, a nutrient or protein source, a marine colloid gelling agent, preferably, a sea weed based gelling agent, and a gelling agent carrier dispersant. The water absorbing agent is a soy fiber, the nutrient source is a soy flour and, preferably, wheat germ, the gelling agent is agar or carrageenan or a combination thereof, and the gelling agent carrier dispersant is vermiculite. Preferably, the composition further includes USDA vitamins and preservatives such as methyl paraben and sorbic acid. Further, soy hulls may be added to improve the texture of the composition. In the case wherein the composition is used for rearing certain species of lepidoptera, the composition further includes a specific host plant material.

The composition is prepared by first mixing the gelling agents with the vermiculite, at room temperature, and then blending the resultant mixture with the soy fiber in a Warring blender for five minutes until a homogenous mixture is formed. The mixture is then transferred to a Hobart mixing bowl where the remaining diet components are added, at room temperature, starting with soy flour and followed by, in sequence, wheat germ, methyl paraben, sorbic acid, and USDA vitamins. The mixture is then blended in a Hobart mixer for several minutes until thoroughly mixed. The resultant dry composition is now suitable for mixing with hot water to form the diet in accordance with the present invention.

The diet is prepared in situ by adding a predetermined amount of dry mixture to a predetermined amount of boiling distilled water and stirring the mixture with a butter knife or the like until thoroughly mixed. In a typical application the diet is dispersed on the interior surface of cups or plastic shoe boxes for mass rearing usage.

In a preferred embodiment of the diet so prepared, the soy fiber is in the range of about 7 to 13 percent, the soy flour is in the range of about 0 to about 5 percent, the agar or carrageenan or combination thereof is in the range of about 1 to 2 percent, the vermiculite is less than 1 percent, the wheat germ is in the range of about 3 to about 6, the USDA vitamins is about 1 percent, the preservative is less than 1 percent and the water in the range of about 75 to 85 percent.

The diet of the present invention has unique properties in that, upon solidification, it remains dispersed on the vertical surface of the cup or shoe box, maintains its moisture and provides a non-drying irregular leaf-like layer and natural leaf-like scaffolding and feeding surface for larvae thereby enhancing the feed response of the larvae. The ability of the diet to remain dispersed on the vertical surface of the rearing cup or box and to attract the feeding larvae thereon causes the formation of a feeding surface which is separate and apart from the bottom surface of the cup where frass and microorganisms accumulate. Accordingly, the effective feeding surface area in the cup or box is not negatively affected by the frass and the microorganisms whereby the rearing of larvae therein is more efficient and economical.

A large variety of insects may be reared en mass on the artificial diet disclosed by the present invention. Examples include, but are not limited to, Lepidoptera spp, Manduca spp, Bombyx spp, Drosophila spp, Anthonomus spp, Danaus plexippus, Vanessa cardui, Vanessa atlanta, Agraulus vanillae, and Nymphalis antiopa.

### DETAILED DESCRIPTION OF THE INVENTION

According to the present invention, a composition is disclosed for the preparation of insect larval rearing media. The composition includes a water absorbing agent, a nutrient or protein source, a marine colloid gelling agent, preferably, a sea weed based gelling agent, and a gelling agent carrier dispersant. The water absorbing agent is a soy fiber, the nutrient source is a soy flour and, preferably, wheat germ, the gelling agent is agar or carrageenan or a combination thereof, and the gelling agent carrier dispersant is vermiculite. Preferably, the composition further includes USDA vitamins and preservatives such as methyl paraben and sorbic acid. Further, soy hulls may be added to improve the texture of the composition. In the case wherein the composition is used for rearing certain species of Lepidoptera, the composition further includes a specific host plant material.

An example of soy fiber used is one sold by Archer Daniels Midland Company under the trademark Nutrisoy which is a soybran derived from the process of dehulling soybeans. It has the following typical proximate data:

| | |
|---|---|
| Moisture | 7% |
| Protein (N × 6.25) | 12% |
| Fat | 2% |
| Ash | 5% |
| Crude Fiber | 35% |
| Other Non-digestibles | 39% |
| Calories PER 100 gm | 70 |

Its dietary fiber composition is 72-75% total dietary fiber, 65-70% insoluble fiber and 5-8% soluble fiber. Its mineral content is potassium (1420 mg/100 gm), sodium (20 mg/100 gm), calcium (521 mg/100 gm), phosphorus (193 mg/100 gm), magnesium (234 mg/100 gm), and heavy metals less than 5 ppm.

Another example of soy fiber is the one sold by The Fibred Group as FI-1 Soy Fiber which typically includes 3.50% moisture, 92.50% total dietary fiber (insoluble), 0.50% fat, 1.3% protein and 2.2% ash with a caloric content of about 0.1 Kcal/gm, a water absorption of about300% and a pH in the range of 6.5 to 7.5.

An example of soy flour suitable for the composition of the present invention is one that is sold by Cargill Soy Protein Products as Product 20070 which typical chemical and physical specifications are 8% maximum moisture, 50% minimum protein, 95% minimum granulation (through 200 Mesh U. S. Sieve), 1.2% maximum fat (ether extraction), 3.5% maximum fiber and 65-75 protein dispersibility index.

Wheat germ as the one sold by Viobin U.S.A., a Division of McShares Inc. under the name VIOBIN Wheat Germ NO. 3 is an example of a wheat germ that may be used in the composition of the present invention. Typically, that product has 32.7% protein, 0.52% fat, 5.71% moisture, 7 ppm hexane, with a bulk density of 0.57 and a granulation of 94.0% (Sieve through #80).

An example of an agar suitable for use in the present invention is the product sold by Fisher Scientific under the name Gracilaria. It a practically odorless, off white to light tan product with gel strength (1.5% solution at 20° C.) of 600-900+ gr/cm² and gel temperature of 38-40° C. Its physical and chemical properties are a particle size of US STD 100 mesh, a maximum moisture of 20.0% a maximum total ash of 6.50% a maximum of acid insoluble ash of 0.50%, a maximum of 3 ppm arsenic, a maximum of 40 ppm heavy metals and a maximum of 10 ppm lead.

An example of carrageenan suitable for the composition of the present invention is the product sold by Sigma Chemicals under the name Carrageenan D2356, an off-white powder with neutral odor and taste. It has a viscosity (1.5% solution, Brookfield LVT, 20 rpm, 75° C.) of 20 cps minimum, an aqueous gel strength (20° C.) of 500-750 g/cm², a pH (1% solution) of 7.0 to 9.5, a particle size (90%) through USS 100 mesh and a loss on drying of 12% maximum. Its contains a maximum of 40 ppm heavy metals, a maximum of 10 ppm lead and a maximum of 3 ppm arsenic.

The composition is prepared by first mixing the gelling agents with the vermiculite, at room temperature, and then blending the resultant mixture with the soy fiber in a Warring blender for five minutes until a homogenous mixture is formed. The mixture is then transferred to a Hobart mixing bowl where the remaining diet components are added at room temperature, starting with soy flour and followed by, in sequence wheat germ, methyl paraben, sorbic acid, and USDA vitamins. The mixture is then blended in a Hobart mixer for several minutes until thoroughly mixed. The resultant dry composition is now suitable for mixing with hot water to form the diet in accordance with the present invention. The dry composition may be transported or stored preferably in a freezer, for a long time until it is mixed with the water to form the wet diet.

The diet is prepared in situ by adding a predetermined amount of dry mixture to a microwave-safe container containing a predetermined amount of boiling distilled water which has been brought to boiling in a microwave oven. The heating in the microwave oven sterilizes the container. The mixture is stirred with a butter knife or the like until thoroughly mixed. In a typical application the diet is allowed to cool for 1 to 2 minutes and is dispensed with a butter knife or the like on the interior vertical surfaces of one, two, or nine ounce rearing cups with the amount being dispensed therein being in the range of about 2 to about 25 ml (about 0.5 to about 4 teaspoons), depending on the size of the cup. The diet is also dispensed in the interior surface of sterilized 1.5 gallon Rubbermaid plastic shoe boxes for mass rearing usage. After the diet is allowed to cool further, the cups and shoe boxes are covered and stored in a refrigerator until needed. Any diet not dispersed in cups or boxes is placed in containers and stored in the refrigerator to be dispersed in cups or boxes at a later time.

In a preferred embodiment of the diet so prepared the soy fiber is in the range of about 7 to 13 percent the soy flour is in the range of about 0 to about 5 percent, the agar or carrageenan or combination thereof is in the range of about 1 to 2 percent, the vermiculite is less than 1 percent, the wheat germ is in the range of about 3 to about 6, the USDA vitamins is about 1 percent, the preservative is less than 1 percent and the water in the range of about 75 to 85 percent. It should be understood that the preferred composition of the dry mixture prior to mixing with water to form the diet should be such so as to cause the formation of a diet having components within these preferred ranges. For example, in order to make a diet with a water content of about 81.6 percent, the preferred embodiment of the dry mixture contains soy fiber in the range of about 40 to about 70 percent soy flour in the range of 0 to about 25 percent, wheat germ in the range of about 20 to about 31.5, agar or carrageenan or combination thereof in the range of about 7 to about 12 percent, vermiculite of less than 3 percent USDA vitamins of about 3 percent and preservative of less than 3 percent.

In a preferred embodiment specific for rearing Lepidoptera (ex. Vanesa cardui), a typical wet diet composition comprises 9.2% soy fiber, 3% soy flour, 3.4% wheat germ, 0.9% agar, 0.9% carrageenan, less than 1% vermiculite gelling agent carrier dispersant, less than 1% vitamins, less than 1% preservatives, and about 81% water. One litter of that composition is prepared by boiling 30 oz (888 ml) of distilled water in a microwave adding 200 g of the dry mix composition thereto and stirring with a butter knife until thoroughly mixed.

In a preferred alternative embodiment of the artificial diet specific for rearing Danaus plexippus a typical wet diet comprises 3% soy fiber, 4% soy flower, 2.5% processed Asclepias speciosa, 2.5% processed Asclepias curassavica, 5% wheat germ 0.88% agar, 0.88% carrageenan, less than 1% vermiculite gelling agent carrier dispersant, less than 1% vitamins, less than 1% preservatives and about 80% water. The gelling agents are mixed with less than 1% vermiculite and then blended with the soy fiber in a blender for five minutes until a homogenous mixture is formed. The mixture is transferred to a Hobart mixing bowl. The other diet components are then added sequentially starting with Asclepias curassavica and followed by Asclepias speciosa, wheat germ, methyl paraben, sorbic acid, and USDA vitamins. The mixture is then blended in a Hobart mixer for several minutes until thoroughly mixed. The processed milkweed (Asclepias Speciosa) is derived from young greenhouse grown plants dried in low humidity environment and ground to a powder, first, in a food processor and, then, in a Warring blender.

In a typical application, a nine (9) oz Solo cup having the diet of the present invention dispersed on the vertical surface thereof is seeded with 6 larvae. Similarly, a Rubbermaid shoe box with the diet of the present invention dispersed on its interior vertical surfaces is seeded with up to 500 larvae of the same size. A coffee filter is placed over the 9 oz Solo cup and a plastic lid with straw slit opening is placed on the cup. A rectangular piece of tulle is fitted over the shoe box followed by a paper towel and the lid which has small holes around the perimeter. Larvae are allowed to pupate on the coffee filter or tulle netting.

The diet of the present invention has unique properties in that, upon solidification, it remains dispersed on the vertical surface of the cup or shoe box, maintains its moisture and provides a non-drying irregular leaf-like layer and natural leaf-like scaffolding and feeding surface for larvae thereby enhancing the feed response of the larvae The ability of the diet to remain dispersed on the vertical surface of the rearing cup or box and to attract the feeding larvae thereon causes the formation of a feeding surface which is separate and apart from the bottom surface of the cup where frass and microorganisms accumulate and which is positioned so as not to receive frass produced by the insect larval. Accordingly, the effective feeding surface area in the cup or box is not negatively affected by the frass and the microorganisms whereby the rearing of larvae therein is more efficient and economical. Further, the diet may be dispersed on vertical surfaces provided by panels, cups or the like placed in the interior of containers such as the Rubbermaid shoe boxes, thereby providing feeding surfaces for mass rearing. Removable horizontal panels may be provided in the mass rearing containers to receive and to contain the frass in a frass space and containment area within the unit which is separate from the feeding area and to facilitate the easy removal of the frass without interfering with the feeding surface and the efficient feeding of the larvae.

The diet disclosed by the present invention is very hygroscopic in that it contains highly water absorbing material that absorb the water present in the rearing environment. As a result, condensation in the rearing container is eliminated and the associated disease problems diminished.

The climate controlled environment in the enclosed units or containers is suitably maintained for rearing insect larvae. Larvae are harvested from the feeding surface. If harvesting of pupae is desired, a pupation surface is provided in the upper portion of the container. Pupae are produced thereon that are harvested at an appropriate time. In the case of insect species that pupate in soil, a pupation media (vermiclite) is placed in the rearing container.

A large variety of insects may be reared en mass on the artificial diet disclosed by the present invention Examples include, but are not limited to, Lepidoptera spp, Manduca spp, Bombyx spp, Drosophila spp, Anthonomus spp, Danaus plexippus, Vanessa cardui, Vanessa Atlanta, Agraulus vanillae, and Nymphalis antiopa.

The following examples further illustrate the invention but are not to be construed as limitations on the scope of the process contemplated herein.

### EXAMPLE 1

A cellulose based cookie dough diet is presently available from Stonefly Industries and marketed as a Soybean-Wheat Germ Manduca Premix-Heliothis Premix diet. The diet is also disclosed in U.S. Pat. No. 4,840,800. The instruction for mixing that diet require mixing 25% by weight of the dry premix with 71% water by weight and 4% by weight white vinegar. According to the instructions, water and vinegar were first mixed in a 19 to 1 ratio. Dry premix was then added and mixed by hand. The final mix had the consistency of a stiff cookie dough or dryer. The resulting water and vinegar concentration was 75%.

Painted lady butterflies (Vanessa cardui) of the order of Lepidoptera were tested according to the instructions provided by the manufacturer. After the Stonefly Industries diet cooled was placed in cups and cooled, each cup was seeded with six early instar painted lady larvae. A total of 300 larvae were seeded. A filter paper was placed over each cup and the lid was snapped on. The cultures were kept at 25 C. for two weeks. Pupae were removed and weighed after the larvae pupated. The pupation rate was 85 percent and the average pupae weight was 425 mg.

### EXAMPLE 2

The cellulose based cookie dough diet presently available from Stonefly Industries was prepared as in Example 1. The dough was placed in two shoe boxes and each box was seeded with one hundred early instar painted lady larvae. A total of 200 larvae were seeded. The dough was applied to the sides of the rearing container with a butter knife. A paper towel was placed under the lid of the shoe box followed by the lid. Multiple holes were drilled on the lid to provide ventilation. The cultures were kept at 25 C. for two weeks. Pupae were removed and weighed after the larvae pupated. The pupation rate was 66.60 percent and the average pupae weight was 375 mg

The procedure was repeated and a total of 225 larvae were seeded. Pupae were removed and weighed after the larvae pupated. The pupation rate was 71.00 percent and the average pupae weight was 449 mg.

### EXAMPLE 3

A standard agar based diet presently used for rearing Lepidoptera order larvae contains soy flour, fiber, wheat germ, brewers yeast vitamins, preservatives It is commercially available from Southland Corporation and is marketed as a multiple species insect diet. The instruction for making one litter of that diet require boiling 930 ml of water, first adding 20 gr of agar dry mix followed by adding 142 g of premix and blending in a Warring blender for 3 to 4 minutes. The resulting water concentration is 85.2%. The diet was tested with painted lady butterflies (Vanessa cardui) of the order of Lepidoptera according to the instructions provided by the diet manufacturer. Accordingly, after the Southland Corporation diet control media was placed in cups and cooled each cup was seeded with six early instar painted lady larvae. A total of 300 larvae were seeded. A filter paper was placed over each cup and the lid was snapped on. The cultures were kept at 25 C. for two weeks. Pupae were removed and weighed after the larvae pupated. The pupation rate was 82 percent and the average pupae weight was 401 mg.

### EXAMPLE 4

The agar based diet described in Example 3 was prepared as in Example 3. The diet was placed in two shoe boxes and each box was seeded with one hundred early instar painted lady larvae. A total of 200 larvae were seeded. The diet was applied in the shoe box as previously described in Example 2. The cultures were kept at 25 C. for two weeks. Pupae were removed and weighed after the larvae pupated. The pupation rate was 50.00 percent and the average pupae weight was 379 mg

The agar based diet described in Example 3 was prepared as in Example 3. The diet was placed in shoe boxes. A total of 120 larvae were seeded. Pupae were removed and weighed after the larvae pupated. The pupation rate was 48 percent and the average pupae weight was 397 mg.

### EXAMPLE 5

A diet in accordance with the present invention was prepared by the mixing steps previously described. More particularly, the gelling agents were mixed with less than 1% vermiculite and then blended with soy fiber in a blender for five minutes until a homogenous mixture was formed. The mixture was transferred to a Hobart mixing bowl. The remaining diet components were then added in sequence starting with the soy flour and followed by wheat germ, methyl paraben, sorbic acid, and USDA vitamins. The mixture is then blended in a Hobart mixer for several minutes until thoroughly mixed. The diet contained 8.2% soy fiber, 1% soy flour, 7% wheat germ, 0.9% agar, 0.9% carrageenan, less than 1% vermiculite gelling agent carrier dispersant, 1% vitamins, less than 1% preservatives, and 80% water.

The diet was placed in cups as previously described and larvae were seeded on the diet by placing six larvae per cup. A total of 450 larvae were seeded. The larvae were allowed sufficient time to pupate. The pupation/eclosure rate was 91% with an average pupae weight of 506 mg.

### EXAMPLE 6

A diet in accordance with the present invention was prepared like in Example 5 except for that the amounts of ingredients were changed to form a diet containing 9.65% soy fiber, 5.70% wheat germ, 1.80% carrageenan, less than 1% vermiculite gelling agent carrier dispersant, less than 1% vitamins, less than 1% preservatives, and 81.60% water.

The diet was placed in cups as previously described and larvae were seeded on the diet by placing six larvae per cup. A total of 280 larvae were seeded. The larvae were allowed sufficient time to pupate. The pupation/eclosure rate was 95% with an average pupae weight of 551 mg.

### EXAMPLE 7

A diet in accordance with the present invention was prepared like in Example 5 except for that the amounts of ingredients were changed to form a diet containing 9.65% soy fiber, 1% soy flour, 3.50% wheat germ, 1.75% carrageenan, less than 1% vermiculite gelling agent carrier dispersant, 1% vitamins, less than 1% preservatives, and 83.00 % water.

The diet was placed in cups as previously described and larvae were seeded on the diet by placing six larvae per cup. A total of 150 larvae were seeded. The larvae were allowed sufficient time to pupate. The pupation/eclosure rate was 91% with an average pupae weight of 496 mg.

### EXAMPLE 8

A diet in accordance with the present invention was prepared like in Example 5 except for that the amounts of ingredients were changed to form a diet containing 8.60% soy fiber, 1.50 soy flour, 6.00% wheat germ, 1.83% agar, less than 1% vermiculite gelling agent carrier dispersant, less than 1% vitamins, less than 1% preservatives, and 81.00% water.

The diet was placed in cups as previously described and larvae were seeded on the diet by placing six larvae per cup. A total of 285 larvae were seeded. The larvae were allowed sufficient time to pupate. The pupation/eclosure rate was 95% with an average pupae weight of 551 mg.

The diet prepared in this example was placed in shoe boxes and larvae were seeded therein for mass rearing. A total of 350 larvae were seeded. The larvae were allowed sufficient time to pupate. The pupation/eclosure rate was 95% with an average pupae weight of 498 mg.

### EXAMPLE 9

A diet in accordance with the present invention was prepared like in Example 5 except for that the amounts of ingredients were changed to form a diet containing 9.30% soy fiber, 1.90 soy flour, 6.00% wheat germ, 0.90% agar, 0.90% carrageenan, less than 1% vermiculite gelling agent carrier dispersant, less than 1% vitamins, less than 1% preservatives, and 79.00% water.

The diet was placed in cups as previously described and larvae were seeded on the diet by placing six larvae per cup. A total of 230 larvae were seeded The larvae were allowed sufficient time to pupate. The pupation/eclosure rate was 98% with an average pupae weight of 498 mg.

### EXAMPLE 10

A diet in accordance with the present invention was prepared like in Example 5 except for that the amounts of ingredients were changed and passion vine was added to form a diet containing 11.60% soy fiber, 1.00 soy flour, 6.00% wheat germ, 1.17% agar, 5% processed passion vine obtained from a nursery, less than 1% vermiculite gelling agent carrier dispersant, less than 1% vitamins, less than 1% preservatives, and 77.00% water

The diet was placed in cups as previously described and Gulf fritillary (Agraulus vanillae) larvae were seeded on the diet by placing six larvae per cup. A total of 30 larvae were seeded The larvae were allowed sufficient time to pupate. The pupation/eclosure rate was 83%.

The diet prepared above excluding the passion vine was tested in rearing larvae. A total of 180 larvae were tested and the pupation rate was 100 percent.

The cellulose based cookie dough diet described in Example 1 presently available from Stonefly Industries was mixed with 5% processed passion vine. Thirty Gulf fritillary (Agraulus vanillae) larvae were tested on this diet. No larvae pupated successfully.

The agar based diet described in Example 3 presently available from Southland Corporation was mixed with 5% processed passion vine. Thirty Gulf fritillary (Agraulus vanillae) larvae were tested on this diet. No larvae pupated successfully.

### EXAMPLE 11

A diet in accordance with the present invention was prepared like in Example 5 except for that the amounts of ingredients were changed to form a diet containing 9.2% soy fiber, 3% soy flour, 5.00% wheat germ, 0.90% agar, 0.90% carrageenan, less than 1% vermiculite gelling agent carrier dispersant, less than 1% vitamins, less than 1% preservatives, and 81.00% water

The diet was placed in cups as previously described and larvae were seeded on the diet by placing six larvae per cup. A total of 206 larvae were seeded. The larvae were allowed sufficient time to pupate. The pupation/eclosure rate was 100% with an average pupae weight of 597 mg. The adult butterflies emerged larger, healthier (with fewer emergence problems such as crippled wings) and more prolific than those of Examples 1 and 3. Moreover, a greater number of larvae pupated. The greater proliferation was evidenced by higher egg production and healthy second and third generation progeny.

The diet prepared in this example was placed in shoe boxes and larvae were seeded therein for mass rearing. A total of 365 larvae were seeded. The larvae were allowed sufficient time to pupate. The pupation/eclosure rate was 96% with an average pupae weight of 559 mg.

### EXAMPLE 12

A diet in accordance with the present invention was prepared like in Example 5 except for that the amounts of ingredients were changed to form a diet specific for rearing Danaus plexippus. The diet comprised 3% soy fiber, 4% soy flour, 2.5% processed Asclepias speciosa, 2.5% processed Asclepias curassavica, 5% wheat germ, 0.88% agar, 0.88% carrageenan, less than 1% vermiculite gelling agent carrier dispersant , less than 1% vitamins, less than 1% preservatives, and about 80% water. The gelling agents were mixed with less than 1% vermiculite and then blended with the soy fiber in a blender for five minutes until a homogenous mixture was formed. The mixture was transferred to a Hobart mixing bowl. The other diet components were then added sequentially starting with Asclepias curassavica and followed by Asclepias speciosa, wheat germ, methyl paraben, sorbic acid, and USDA vitamins. The mixture was then blended in a Hobart mixer for several minutes until thoroughly mixed. The processed milkweed (Asclepias Speciosa) was derived from young greenhouse grown plants dried in low humidity environment and ground to a powder first, in a food processor and, then, in a Warring blender

The diet was placed in a shoe box as previously described and Danaus plexippus larvae were seeded on the diet. A total of 60 larvae were seeded. The larvae were allowed sufficient time to pupate. The pupation/eclosure rate was 75%.

### EXAMPLE 13

A diet in accordance with the present invention was prepared like in Example 5 except for that the amounts of ingredients were changed to omit the gelling agents. The diet contained 14.33% soy fiber, 2.0% soy flour, 4.0% wheat germ, less than 1% vermiculite gelling agent carrier dispersant, less than 1% vitamins, less than 1% preservatives, and 80.00 % water. On cooling the prepared diet did not gel and remained a thick watery slurry that and was not acceptable for rearing larvae.

The diet was placed in cups as previously described and larvae were seeded on the diet by placing six larvae per cup. Larvae refused the diet and died prior to pupating. Moreover mold was detected in the rearing cup The pupation/eclosure rate was 0%.

### EXAMPLE 14

The test diet of Example 6 was spread along the sides of a Rubbermaid shoe box. The box was seeded with 25 Manduca sexta larvae. A plastic mesh scaffold was pressed into the diet just prior to the diet gelling. Vermiculite was added to the bottom of the rearing container to provide a media for pupation. Twenty three (23) out of 25 Manduca sexta were reared to healthy adult hummingbird hawkmoths that went on to reproduce successfully.

### EXAMPLE 15

The diet prepared as in Example 8 was mixed with 5% (dry basis) processed Milkweed (Asclepias spp.) that was dried and then chopped in a food processor. The diet was spread in 9 oz cups and seeded with Monarch larvae per cup. One hundred fifty (150) Danaus plexippus larvae were tested on this diet. One hundred twenty two (122) out of 150 larvae successfully pupated and eclosed as normal adults.

Sixty Danaus plexippus were also tested by using the same composition in a shoe box. Forty five (45) out of 60 larvae successfully pupated and eclosed (emerged as pupae as normal adults) The cellulose based cookie dough diet described in Example 1 presently available from Stonefly Industries was mixed with 5% (dry basis) processed Milkweed (Asclepias spp.) that was dried and then chopped in a food processor. The diet was spread in 9 oz cups and seeded with 1 Monarch larvae per cup. Thirty Danaus plexippus larvae were tested on this diet. No larvae pupated successfully.

The agar based diet described in Example 3 presently available from Southland Corporation was mixed with 5% (dry basis) processed Milkweed (Asclepias spp.) that was dried and then chopped in a food processor. The diet was spread in 9 oz cups and seeded with 1 Monarch larvae per cup Thirty Danaus plexippus larvae were tested on this diet. None of the larvae tested developed into monarch adult butterflies.

### EXAMPLE 16

The cellulose based cookie dough diet that is presently available from Stonefly Industries and marketed as a Soybean-Wheat Germ Manduca Premix-Heliothis Premix diet was prepared as in Example 1 except for that water was added to increase the water content of the diet from 75% to 80%. More particularly, twenty grams (20 g) of the Soybean-Wheat Germ “Manduca Premix-Heliothis Premix” diet was mixed with 80 ml of distilled water and then kneaded into a dough. Diet was dispersed in cups and a shoe box. Larvae were seeded on the diet as described previously The pupation/eclosure rate dropped to 50% with an average pupae weight of 435 mg. The diet produced a greenish white mold in the rearing cups and shoe box with the mold being more pronounced in the shoe box. Further, third and fourth instar larvae refused the diet and died.

### EXAMPLE 17

A diet in accordance with the present invention was prepared like in Example 5 except for that the amounts of ingredients were changed to form a diet containing 13.33% soy fiber, 1.9% soy flower, 6.0% wheat germ, 0.90 agar, 0.90% carrageenan, less than 1% vermiculite gelling agent carrier dispersant, less than 1% vitamins, less than 1% preservatives, and 75.00% water.

The diet was placed in cups as previously described and larvae were seeded on the diet by placing six larvae per cup. A total of 125 larvae were seeded. The larvae were allowed sufficient time to pupate. The pupation/eclosure rate was 77% which is substantially lower than the rate present when the water content was higher. The average pupae weight was 465 mg. Further, third and fourth instar larvae grew slower on the diet and a few refused the diet, and died.

### EXAMPLE 18

A diet in accordance with the present invention was prepared like in Example 5 except for that the amounts of ingredients were changed to form a diet containing 7.60% soy fiber, 1.5% soy flower, 4.0% wheat germ, 1.83 agar, less than 1% vermiculite gelling agent carrier dispersant, less than 1% vitamins, less than 1% preservatives, and 85.20% water.

The diet was placed in cups and a shoe box as previously described and larvae were seeded on the diet. The larvae were allowed sufficient time to pupate. In the cups, the pupation/eclosure rate was 79% which is substantially lower than the rate present when the water content was higher. The average pupae weight was 465 mg. Further, third and fourth instar larvae grew slower on the diet and a few refused the diet.

In the shoe box the pupation/eclosure rate dropped to 67% when compared to diet with lower water rate with an average pupae weight of 458 mg. In addition many second and third instar larvae were found dead in the center of the shoe box.

### EXAMPLE 19

The procedure of Example 6 was repeated except for that the diet was prepared by mixing the dry premix with cold distilled water instead of hot boiling distilled water. The diet did not gel and produced a thick watery slurry that was not suitable for rearing larvae. The pupation/eclosure rate dropped to 0%. Also, third and fourth instar larvae grew slower on the diet and many larvae refused the diet and died. On completion of the experiment mold was evident on the larvae and the diet.

Although the invention is described with respect to specific embodiments and modifications, the details hereof are not to be construed as limitation except to the extent indicated in the following claims.

What is claimed is:

1. A composition suitable for the preparation of insect larval rearing media, comprising:
a water absorbing agent;
a nutrient source; and
a marine colloid gelling agent.

2. An insect larval rearing media, comprising:
a water absorbing agent;
a nutrient source;
a sea weed based gelling agent; and
water.

3. A composition according to claim 2 wherein the water absorbing agent is a soy fiber.

4. A composition according to claim 3 wherein the soy fiber is in the range of about 7 to 13 percent.

5. A composition according to claim 2 wherein the nutrient source is a soy flour.

6. A composition according to claim 5 wherein the soy flour is in the range of about 0 to about 5 percent.

7. A composition according to claim 2 wherein the nutrient source is a wheat germ.

8. A composition according to claim 7 wherein the amount of the wheat germ is in the range of about 3 to about 6 percent.

9. A composition according to claim 2 wherein the gelling agent is an agar.

10. A composition according to claim 9 wherein the agar is in the range of about 1 to 2 percent.

11. A composition according to claim 19 wherein the gelling agent is a carrageenan.

12. A composition according to claim 11 wherein the carrageenan is in the range of about 1 to 2 percent.

13. A composition according to claim 2 further including a vermiculite gelling agent carrier dispersant.

14. A composition according to claim 13 wherein the vermiculite gelling agent carrier dispersant is less than 1 percent.

15. A composition according to claim 2 further including a vitamin.

16. A composition according to claim 2 further including a preservative.

17. A composition according to claim 2 wherein the amount of water is in the range of about 77 to 85 percent by weight.

18. A composition according to claim 1 wherein the composition can be readily mixed with hot water to form an insect larval rearing media.

19. A method of rearing insect larval that produce frass, comprising the step of applying a feeding composition on a first surface which is positioned so as not to receive frass produced by the insect larval.

20. The method according to claim 19 further including the step of providing a second surface for receiving the frass produced by the insect larval.

21. The method according to claim 20 wherein the second surface is substantially horizontal.

22. The method according to claim 19 wherein the feeding composition includes a water absorbing agent, a nutrient source, a marine colloid gelling agent and water.

23. The method according to claim 19 wherein the step of applying the feeding composition includes the step of simulating a leaf-like scaffolding.

24. The method according to claim 19 wherein the first surface is substantially vertical.

25. A method of rearing insect larvae in an enclosed unit, comprising the steps of:
maintaining a climate controlled environment suitable for rearing insect larvae;
applying a diet medium suitable for feeding the insect larvae on a vertical feeding panel disposed in the enclosed unit to form a feeding area; and
including a frass space and containment area within the unit which is separate from the feeding area.

26. The method according to claim 25 further including the step of providing a pupation surface in the unit.

27. The method according to claim 25 further including the step of harvesting larvae from the feeding surface.

28. The method according to claim 26 further including the steps of:
producing pupae; and
harvesting the pupae from the pupation surface.

29. The method according to claim 25 further including the step of placing a pupation media containing vermiclite in the unit.
